(19) United States
(12) Patent Application Publication
(10) Pub. No.: US 2019/0307109 A1
(43) Pub. Date: Oct. 10, 2019

(54) BAIT GRASPING DEVICE

(71) Applicant: Anthony R. Dano, Brainard, MN (US)

(72) Inventor: Anthony R. Dano, Brainard, MN (US)

(21) Appl. No.: 16/377,419

(22) Filed: Apr. 8, 2019

Related U.S. Application Data
(60) Provisional application No. 62/655,508, filed on Apr. 10, 2018.

(51) Int. Cl. A01K 83/06

(52) U.S. Cl. CPC A01K 83/06

(57) ABSTRACT

A bait grasping device for fishing includes first and second grasping members pivotally engaged together with a spring. The spring is tensioned by the pivotal rotation of the first and second inwardly directed prongs of the lower portion of the first and second grasping members away from each other. The spring exerts compression force to position the first and second inwardly directed prongs together to grasp bait. A hook assembly having a hook, an elongate member and an eyelet, is engaged to the first and second grasping members by passing the elongate member through the first and second grasping members and the spring. The hook is disposed proximate to a head of the bait and the first and said second inwardly directed prongs grasp opposite sides of the bait.

### CROSS-REFERENCE TO RELATED APPLICATIONS

This application claims the benefit of U.S. Provisional Patent Application Ser. No. 62/655508 filed Apr. 10, 2018, which is incorporated by reference herein in its entirety.

### FIELD OF THE INVENTION

The invention disclosed in this application relates to a fishing device which prolongs the longevity of bait used during fishing activities. This invention is also directed to a hook which is integral to the device, and the positioning of the hook in an optimal location to facilitate the catching of fish.

### BACKGROUND

Fisherman enjoy catching fish. One method which has been used by fisherman to catch fish is to use live bait in order to improve the attraction of the fish to the lure. In the past, live bait attached to a hook or lure generally moved with an inhibited motion as compared to a natural swimming motion of the bait. In addition, live bait used during fishing activities experienced a shortened lifespan providing to a fisherman a limited amount of time before motion of the bait terminated.

In the past various devices have been used by fisherman with live bait during fishing activities. The known devices have primarily employed a hook, where a portion of the hook is passed through a portion of the live bait, in order to secure the bait to the hook. Naturally the passing of a portion of a hook through a portion of live bait, reduces the longevity, motion and duration of motion of the bait during fishing activities. Therefore, a fisherman is required to frequently replace bait following the perishing of the bait.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. § 1.56(a) exists.

All U.S. patents and applications and all other published documents mentioned anywhere in this application are incorporated herein by reference in their entireties.

Without limiting the scope of the invention, a brief description of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. § 1.72.

### GENERAL DESCRIPTION OF THE INVENTION

In one alternative embodiment, the bait grasping device includes a grasping element, the grasping element having a first grasping member pivotally engaged to a second grasping member, and a spring in operative engagement between the first grasping member and the second grasping member, the spring being constructed and arranged to permit the pivotal separation of a portion of the first grasping member from a portion of the second grasping member prior to engagement of the first grasping member and the second grasping member to bait, the spring being further constructed and arranged to pivotally position a portion of the first grasping member towards a portion of the second grasping member during the engagement of the bait to the grasping element, and a hook assembly, the hook assembly having a hook, an elongate member and an eyelet, the elongate member facilitating the engagement of the first grasping member relative to the second grasping member, wherein the hook is disposed proximate to a head of bait and the first grasping member and the second grasping member are constructed and arranged for positioning on opposite sides of the bait, and the eyelet is disposed upwardly relative to the hook during fishing activities.

In another alternative embodiment, the first grasping member has at least one first interface member and the second grasping member has at least one second interface member.

In another alternative embodiment, each of the first interface member and the second interface member have a central opening.

In another alternative embodiment, the spring includes a central passage.

In another alternative embodiment, the elongate member passes through the central openings of the first interface member and the second interface member, the elongate member further passing through the central passage.

In another alternative embodiment, the elongate member has a releasable attachment portion wherein the releasable attachment portion is disposed at an angle relative to the elongate member during engagement between the first interface member, the second interface member and the spring.

In another alternative embodiment, the hook has a curved section and a point, the curved section being positioned proximate to a head of the bait and the point being positioned upwardly and rearwardly relative to the curved section.

In another alternative embodiment, the bait is releasably engaged to the bait grasping device.

In another alternative embodiment, the first grasping member includes a first pinching portion and a first bait engagement clamp, the first bait engagement clamp having a plurality of first inwardly directed arcuate prongs.

In another alternative embodiment, the second grasping member includes a second pinching portion and a second bait engagement clamp, the second bait engagement clamp having a plurality of second inwardly directed arcuate prongs.

In another alternative embodiment, the hook includes the eyelet.

In another alternative embodiment, the elongate member includes the eyelet.

In another alternative embodiment, the hook has a hook eyelet, the elongate member has the eyelet, and the hook has an angular offset portion between the hook eyelet and the curved section.

In another alternative embodiment, a bait grasping device includes a grasping element, the grasping element having a first grasping member pivotally engaged to a second grasping member, the first grasping member having at least one first interface member, the second grasping member having at least one second interface member, each of the first interface member and the second interface member having a central opening, and a spring in operative engagement between the first grasping member and the second grasping member, the spring being constructed and arranged to permit the pivotal separation of a portion of the first grasping member from a portion of the second grasping member prior to engagement of bait to the grasping element, the spring being further constructed and arranged to pivotally position a portion of the first grasping member towards a portion of the second grasping member during the engagement of the bait to the grasping element, and a hook assembly, the hook assembly having a hook, an elongate member, and an eyelet, the elongate member having a releasable attachment portion, the releasable attachment portion being disposed at an angle relative to the elongate member when the first grasping member, second grasping member, and spring are aligned with and engaged to each other, the elongate member being positioned through the central openings and the spring, wherein the hook is disposed proximate to a head of the bait and the hook includes a curved section and a point, wherein the curved section is positioned proximate to the head of the bait and the point extends rearwardly and rearwardly from a position proximate to the head of the bait, the first grasping member and the second grasping member being constructed and arranged for positioning on opposite sides of the bait, and the eyelet extends upwardly from the hook assembly during fishing activities.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE DRAWINGS

FIG. 1 is an isometric environmental view on one alternative embodiment of the bait grasping device;

FIG. 2 is a front side elevation view of one alternative embodiment of the bait grasping device;

FIG. 3 is a right side elevation view of one alternative embodiment of the bait grasping device;

FIG. 4 is a top plan view of one alternative embodiment of the bait grasping device;

FIG. 5 is a side perspective view of one alternative embodiment of the bait grasping device;

FIG. 6 is a side environmental view on one alternative embodiment of the bait grasping device;

FIG. 7 is an alternative cross-sectional side view of the bait grasping device taken along the line 7-7 of FIG. 2; and

FIG. 8 is an alternative cross-sectional side view of the bait grasping device taken along the line 8-8 of FIG. 5.

### DETAILED DESCRIPTION OF THE PREFERRED EMBODIMENTS

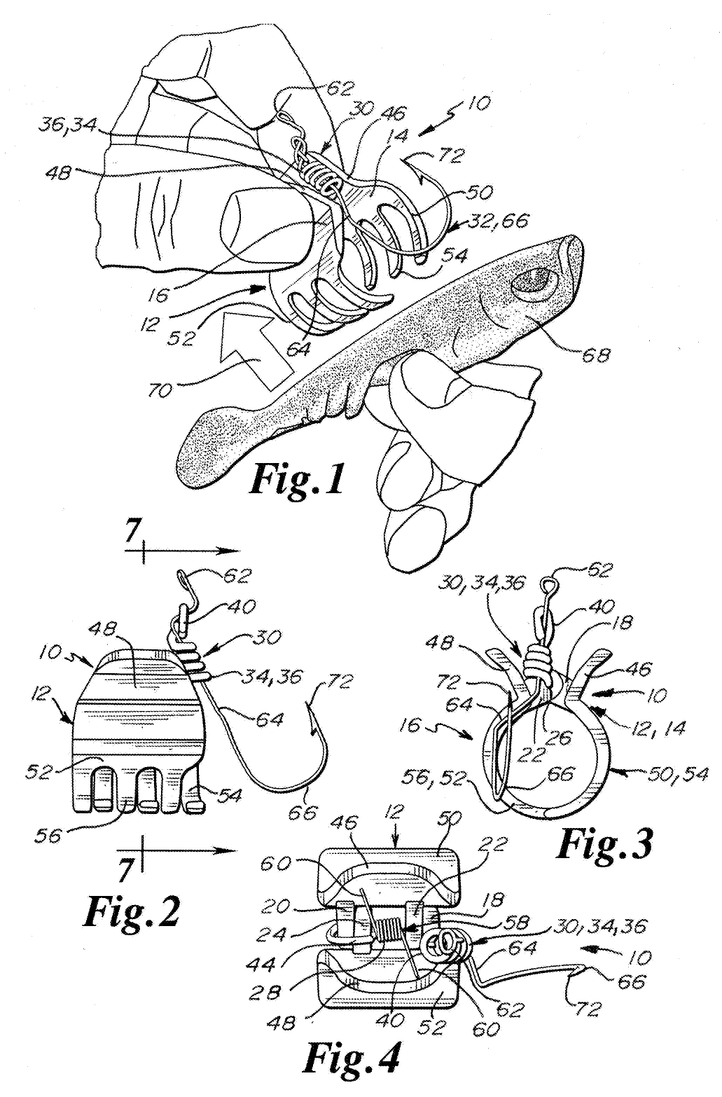

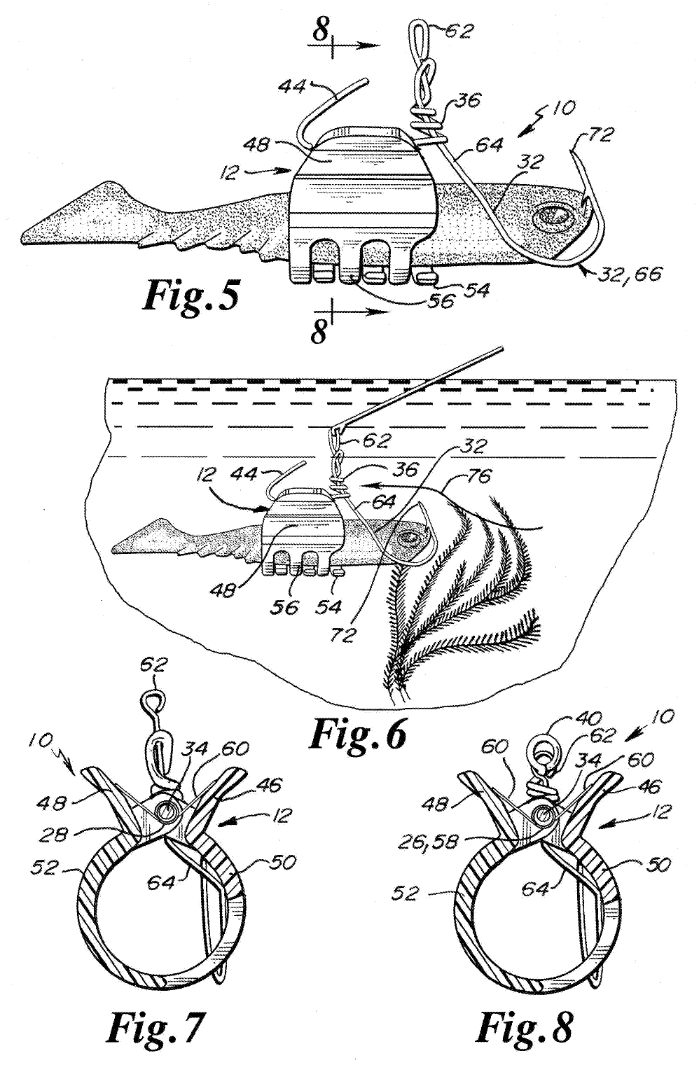

Referring to FIGS. 1 through 8, generally the bait grasping device is identified by reference numeral 10. The bait grasping device 10 includes a grasping element 12. Grasping element 12 includes a first grasping member 14 having a first pinching portion 46. Grasping element 12 also includes a second grasping member 16 having a second pinching portion 48.

In some embodiments, the lower portion of the first grasping member 14 includes a first bait engagement clamp 50. The lower portion of the second grasping member 16 includes a second bait engagement clamp 52. The first bait engagement clamp 50 and the second bait engagement clamp 52 functioning as opposing jaws to grasp bait within the grasping element 12.

In at least one alternative embodiment, the first pinching portion 46 includes a first interface member 18 and a second interface member 20. The second pinching portion 48 includes a third interface member 22 and a fourth interface member 24.

In at least one additional alternative embodiment, the first pinching portion 46 extends angularly outwardly and upwardly away from the location of first interface member 18 and the second interface member 20. The first interface member 18 and the second interface member 20 may be integral to the rear surface of the first pinching portion 46 extending substantially horizontally inwardly relative thereto. Each of the first interface member 18 and the second interface member 20 preferably include an aligned central opening 26 therethrough.

In at least one embodiment, the second pinching portion 48 extends angularly outwardly and upwardly, in an opposite direction, relative to the first pinching portion 46. The second pinching portion 48 further extends angularly outwardly and upwardly relative to the location of the third interface member 22 and the fourth interface member 24. The third interface member 22 and the fourth interface member 24 may be integral to the rear surface of the second pinching portion 48 extending substantially horizontally inwardly relative thereto. Each of the third interface member 22 and the fourth interface member 24 preferably include an aligned central opening 26 therethrough.

The first grasping member 14 in some embodiments is a mirror image of the second grasping member 16. In some embodiments the first bait engagement clamp 50 preferably has a top portion which extends angularly outwardly and downwardly from the area proximate to the first interface member 18 and second interface member 20. The first bait engagement clamp 50 also includes a plurality of first inwardly directed arcuate prongs 54 which initially extend outwardly relative to the first grasping member 14 and then which curve inwardly toward the interior of the grasping element 12 proximate to the lower end of the grasping element 12.

In some embodiments, the second bait engagement clamp 52 has a top portion which extends angularly outwardly and downwardly from the area proximate to the third interface member 22 and the fourth interface member 24.

In some embodiments, the second bait engagement clamp 52 includes a plurality of second inwardly directed arcuate prongs 56 which initially extend outwardly and downwardly relative to the second grasping member 16 and then which curve inwardly toward the interior of the grasping element 12 proximate to the lower end of the grasping element 12.

In some embodiments the first inwardly directed arcuate prongs 54 and the second inwardly directed arcuate prongs 56 may be barbs, may be curved, of a single piece construction, of two or more piece construction, or include other features to facilitate the engagement and retention of bait between the first and second inwardly directed arcuate prongs 54, 56 respectively. The first and second inwardly directed arcuate prongs 54, 56 in turn may be disposed to the exterior opposite sides of the body portion of the bait, such as a minnow 68, compressing the body of the minnow in order to secure the minnow to the bait grasping device 10.

In some embodiments each of the first and second inwardly directed arcuate prongs 54, 56 may have the same or a different number of individual prong elements. In addition the number of prong elements may vary in number from a single prong on each of the first and second inwardly directed arcuate prongs 54, 56 to two, three, four, or five or more individual prong elements. The number of individual prong elements on each of the first and second inwardly directed arcuate prongs 54, 56 may be determined at the discretion of an individual and dependent on the type and size of bait to be used during fishing activities.

In some embodiments, the grasping element 12 is opened by the squeezing of the first pinching portion 46 inwardly towards the second pinching portion 48 which in turn will cause the first and second inwardly directed arcuate prongs 54, 56 to separate outwardly relative to each other in order to establish an opening therebetween. The open area which is established/formed between the first and second inwardly directed arcuate prongs 54, 56 may then be positioned over the upper back or dorsal fin portion of a minnow 68. (Arrow 70, FIG. 1) Following the positioning of the minnow 68 between the first and second inwardly directed arcuate prongs 54, 56 then the first and second pinching portions 46, 48 may be released relative to each other and permitted to separate, causing the first and second inwardly directed arcuate prongs 54, 56 to compress together and to engage the opposite sides of the body of a minnow 68 pinching/securing the minnow 68 therebetween.

In a preferred embodiment, a spring 28 having a central passage 58 is aligned with the central opening 26 of each of the first, second, third and fourth interface members 18, 20, 22 and 24. The spring 28 additionally includes opposite extension contact ends 60, where one of the extension contact ends 60 engages each of the rear surfaces of the first and second pinching portions 46, 48 respectively. The manipulation of the first and second pinching portions 46, 48 together creates tension on the spring 28 whereupon the release of the first and second pinching portions 46, 48 will cause the contact ends 60 to decompress, and to separate the first pinching portion 46 away from the second pinching portion 48 and will simultaneously actuate the first inwardly directed arcuate prong 54 towards the second inwardly directed arcuate prong 56 in order to grasp the opposite exterior sides of the body of bait such as a minnow 68.

As previously identified, the central passage 58 of the spring 28 is aligned with the central opening 26 of each of the first, second, third and fourth interface members 18, 20, 22 and 24 respectively. An elongate element 34 of the hook assembly 30 is disposed through the central passage 58 and the central openings 26 of the first, second, third and fourth interface members 18, 20, 22 and 24. The elongate element 34 functions as an alignment member and as an axle permitting rotational movement of the first grasping member 14 relative to the second grasping member 16 preventing undesirable separation therebetween.

As may be seen in figures one through eight the hook assembly 30 includes a hook 32 having a point 72 which may be barbed or un-barbed at the preference of an individual. The hook assembly 30 additionally includes the elongate member 34 and may further include an eyelet 40. In some embodiments the hook assembly includes a hook attachment section 36 which may be repeatedly wound around the shank portion of the hook 32. The hook may include a hook eyelet 62 and/or the hook attachment section 36 may terminate in an eyelet 40. The hook eyelet 62 or the eyelet 40 are constructed and arranged for attachment to a fishing line 74. The shank portion of the hook 32 is the portion between the hook eyelet 62 and the curved section 66.

In some embodiments the hook attachment section 36 may not include an eyelet 40 and may terminate at a distal end as engaged to the shank of the hook 32. Alternatively, the distal end of the hook attachment section 36 may pass through the hook eyelet 62 and be formed into the eyelet 40.

In at least one embodiment, the distal end of the elongate member 34 includes an attachment element or portion 44 which may be used to releasably secure the elongate member to the first and second grasping members 14, 16 respectively. The attachment element or portion 44 may be bent in a direction for positioning proximate and exterior to the spring 28 and the first, second, third and fourth interface members 18, 20, 22 and 24 respectively. In some embodiments, the bending of the releasable attachment element or portion 44 functions to prevent the separation of the hook assembly 30 from the grasping element 12 during fishing activities.

In some embodiments the hook assembly 30 may include a first elevation arm extending upwardly from the hook attachment section 36, a line attachment section at the top of the first elevation arm, and a second elevation arm having a releasable attachment element, the second elevation arm descending from the line attachment section. The hook assembly 30 may be substantially triangular or other shape extending upwardly from the elongate member 34 and the grasping element 12. In an alternative embodiment, any combination of these elements may be integral to each other or engaged to each other by mechanical means such as welding, the use of adhesives, or wire or line to facilitate manufacture.

In some embodiments, the shank portion of the hook 32 may include an angular offset portion 64 which is used to traverses across a portion of the top of bait to position the hook 32 adjacent to the head of the bait. In at least one embodiment, the curved portion 66 of the hook 32 is positioned proximate to the head portion of bait. The positioning of the point 72 upwardly and rearwardly relative to the bait occurs because fish strike the head portion of bait more frequently than the tail portion of bait, during fishing activities. The positioning of the point 72 upwardly and rearwardly relative to the head of the bait facilitates/improves the likelihood of catching fish during the use of the bait grasping device 12 during fishing activities.

In some embodiments, the hook 32 may vary in size to accommodate the use of varying sized bait during fishing activities. During use with larger bait/minnows, the size of the bait grasping device 10, first grasping element 14, second grasping element 16, spring 28, and first and second inwardly directed arcuate prongs 54, 56 will be proportionally increased in size so that the grasping and securing of the bait/minnow to the bait grasping device 10 occurs.

The grasping element 12 may be formed of plastic, metal, and/or composite materials and combinations thereof at the discretion of an individual. The hook assembly 30 is preferably formed of metal material. The grasping element 12 may be formed of any desired color of material to facilitate observation, by and attraction of, fish during fishing activities.

In some embodiments the first grasping member 14 and the second grasping member 16 may be formed of material having any desired color including but not limited to amber, orange, neon orange, blue (light, dark, neon or any desired shade), black, green (light, dark, neon or any desired shade), red (light, dark, neon or any desired shade) and yellow. In addition, the first grasping member 14 and the second grasping member 16 may be formed of material having any desired combinations of colors or colored markings suitable to attract fish. It should be noted that colors identified herein are provided for example, and that the colors identified are not restricted to any particular colors or marking combinations and/or options which may be used in the minnow clip/bait grasping device 10.

In a preferred embodiment the bait grasping device 10, including the hook 32, does not penetrate into, or exit from, any portion of the bait or minnow 68. The absence of penetration into the bait increases the lifespan and viability of the bait during fishing activities. In addition the absence of penetration of a hook 32 into the bait improves and prolongs the natural motion of the bait during fishing activities.

It should be noted that the first and second bait engagement clamps 50, 52 respectively are preferably formed of sturdy plastic, metal, composite, other material or combinations thereof which will not fracture or fail when used in fishing activities while securing bait to the bait grasping device 10. In addition the materials selected for the bait grasping device 10 preferably do not corrode or loose functionality following repeated exposures to water.

In at least one preferred embodiment the spring 28 in association with the first and second bait engagement clamps 50, 52 respectively, exert squeezing pressure on the exterior sides of the body of bait, such as minnow 68. The first and second bait engagement clamps 50, 52 respectively do not penetrate into the opposite sides of the bait. Further, the squeezing pressure as transferred from the spring 28 to the first and second bait engagement clamps 50, 52 is sufficient to grasp and hold a minnow 68 during fishing activities without undesirable separation of bait from the bait grasping device 10. The sufficiency of the grasping pressure on the bait is also sufficient to prohibit separation of the bait from the bait grasping device 10 when the bait and bait grasping device 10 contact underwater obstacles during fishing activities. (FIG. 6)

In at least one preferred embodiment the positioning of the hook 32 adjacent to the head of the bait, where the curved section 66 of the hook is disposed forwardly proximate to the head or front of a minnow, facilitates the passing of the bait grasping device 10 through weeds and underwater vegetation. The position and direction of the curved section 66 of the hook 32 relative to the bait improves the weed-less performance of the bait grasping device 10 with the water movement indicated by arrow 76 in FIG. 6 passing the bait grasping device 10 in a direction from the head to the tail of the bait.

In a first alternative embodiment, the bait grasping device includes a grasping element, the grasping element having a first grasping member pivotally engaged to a second grasping member, and a spring in operative engagement between the first grasping member and the second grasping member, the spring being constructed and arranged to permit the pivotal separation of a portion of the first grasping member from a portion of the second grasping member prior to engagement of the first grasping member and the second grasping member to bait, the spring being further constructed and arranged to pivotally position a portion of the first grasping member towards a portion of the second grasping member during the engagement of the bait to the grasping element, and a hook assembly, the hook assembly having a hook, an elongate member and an eyelet, the elongate member facilitating the pivotal rotation of the first grasping member relative to the second grasping member, wherein the hook is disposed proximate to a head of bait and the first grasping member and the second grasping member are constructed and arranged for positioning on opposite sides of the bait, and the eyelet is disposed upwardly relative to the hook during fishing activities.

In a second alternative embodiment according to the first alternative embodiment, the first grasping member has at least one first interface member and the second grasping member has at least one second interface member.

In a third alternative embodiment according to the second alternative embodiment, each of the first interface member and the second interface member have a central opening.

In a fourth alternative embodiment according to the third alternative embodiment, the spring includes a central passage.

In a fifth alternative embodiment according to the fourth alternative embodiment, the elongate member passes through the central openings of the first interface member and the second interface member, the elongate member further passing through the central passage.

In a sixth alternative embodiment according to the fifth alternative embodiment, the elongate member has a releasable attachment portion wherein the releasable attachment portion is disposed at an angle relative to the elongate member during engagement between the first interface member, the second interface member and the spring.

In a seventh alternative embodiment according to the sixth alternative embodiment, the hook has a curved section and a point, the curved section being positioned proximate to a head of the bait and the point being positioned upwardly and rearwardly from the head of the bait.

In an eighth alternative embodiment according to the seventh alternative embodiment, the bait is releasably engaged to the bait grasping device.

In a ninth alternative embodiment according to the eighth alternative embodiment, the first grasping member includes a first pinching portion and a first bait engagement clamp, the first bait engagement clamp having a plurality of first inwardly directed arcuate prongs.

In a tenth alternative embodiment according to the ninth alternative embodiment, the second grasping member includes a second pinching portion and a second bait engagement clamp, the second bait engagement clamp having a plurality of second inwardly directed arcuate prongs.

In an eleventh alternative embodiment according to the tenth alternative embodiment, the hook includes the eyelet.

In a twelfth alternative embodiment according to the tenth alternative embodiment, the elongate member includes the eyelet.

In a thirteenth alternative embodiment according to the tenth alternative embodiment, the hook has a hook eyelet, the elongate member has the eyelet, and the hook has an angular offset portion between the hook eyelet and the curved section.

In a fourteenth alternative embodiment, a bait grasping device includes a grasping element, the grasping element having a first grasping member pivotally engaged to a second grasping member, the first grasping member having at least one first interface member, the second grasping member having at least one second interface member, each of the first interface member and the second interface member having a central opening, and a spring in operative engagement between the first grasping member and the second grasping member, the spring being constructed and arranged to permit the pivotal separation of a portion of the first grasping member from a portion of the second grasping member prior to engagement of bait to the grasping element, the spring being further constructed and arranged to pivotally position a portion of the first grasping member towards a portion of the second grasping member during the engagement of the bait to the grasping element, and a hook assembly, the hook assembly having a hook, an elongate member, and an eyelet, the elongate member having a releasable attachment portion, the releasable attachment portion being disposed at an angle relative to the elongate member when the first grasping member, second grasping member, and spring are aligned with and engaged to each other, the elongate member being positioned through the central openings and the spring, wherein the hook is disposed proximate to a head of the bait and the hook includes a curved section and a point, wherein the curved section is positioned proximate to the head of the bait and the point extends rearwardly and upwardly from a position proximate to the head of the bait, the first grasping member and the second grasping member being constructed and arranged for positioning on opposite sides of the bait, and the eyelet extends upwardly from the hook assembly during fishing activities.

In a fifteenth alternative embodiment according to the fourteenth alternative embodiment, the bait is releasably engaged to the bait grasping device.

In a sixteenth alternative embodiment according to the fifteenth alternative embodiment, the first grasping member includes a first pinching portion and a first bait engagement clamp, the first bait engagement clamp having a plurality of first inwardly directed arcuate prongs.

In a seventeenth alternative embodiment according to the sixteenth alternative embodiment, the second grasping member includes a second pinching portion and a second bait engagement clamp, the second bait engagement clamp having a plurality of second inwardly directed arcuate prongs.

In an eighteenth alternative embodiment according to the seventeenth alternative embodiment, the hook has the eyelet.

In a nineteenth alternative embodiment according to the seventeenth alternative embodiment, the elongate member has the eyelet.

In a twentieth alternative embodiment according to the seventeenth alternative embodiment, the hook has a hook eyelet and the elongate member has the eyelet, the hook also having an angular offset portion between the hook eyelet and the curved section.

This completes the description of the preferred and alternate embodiments of the invention. Those skilled in the art may recognize other equivalents to the specific embodiment described herein which equivalents are intended to be encompassed by the claims attached hereto.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

These and other embodiments which characterize the invention are pointed out with particularity in the claims annexed hereto and forming a part hereof However, for further understanding of the invention, its advantages and objectives obtained by its use, reference should be made to the drawings which form a further part hereof and the accompanying descriptive matter, in which there is illustrated and described embodiments of the invention.

I claim:

1. A bait grasping device comprising:
a grasping element, said grasping element comprising a first grasping member pivotally engaged to a second grasping member, and a spring in operative engagement between the first grasping member and the second grasping member, said spring being constructed and arranged to permit the pivotal rotation of the first grasping member from the second grasping member prior to engagement of the first grasping member and the second grasping member to said bait, said spring being further constructed and arranged to pivotally rotate the first grasping member towards the second grasping member during the engagement of the bait to the grasping element; and
a hook assembly, the hook assembly comprising a hook, an elongate member and an eyelet, said elongate member being engaged to said first grasping member and said second grasping member and said spring,
wherein said hook is disposed proximate to a head of said bait and said first grasping member and said second grasping member are constructed and arranged for positioning on opposite sides of said bait, and said eyelet being disposed upwardly relative to said hook during fishing activities.

2. The bait grasping device according to claim 1, wherein said first grasping member has at least one first interface member and the second grasping member has at least one second interface member.

3. The bait grasping device according to claim 2, wherein each of the first interface member and the second interface member comprise a central opening.

4. The bait grasping device according to claim 3, said spring further comprising a central passage.

5. The bait grasping device according to claim 4, said elongate member passing through said central openings of said first interface member and said second interface member, said elongate member further passing through said central passage.

6. The bait grasping device according to claim 5, said elongate member having a releasable attachment portion wherein said releasable attachment portion is disposed at an angle relative to said elongate member.

7. The bait grasping device according to claim 6, said hook having a curved section and a point, said curved section being positioned proximate to said head of said bait and said point being positioned upwardly and rearwardly from said head of said bait.

8. The bait grasping device according to claim 7, wherein said bait is releasably engaged to said bait grasping device.

9. The bait grasping device according to claim 8, said first grasping member comprising a first pinching portion and a first bait engagement clamp, said first bait engagement clamp comprising a plurality of first inwardly directed arcuate prongs.

10. The bait grasping device according to claim 9, said second grasping member comprising a second pinching portion and a second bait engagement clamp, said second bait engagement clamp comprising a plurality of second inwardly directed arcuate prongs.

11. The bait grasping device according to claim 10, wherein said hook comprises said eyelet.

12. The bait grasping device according to claim 10, wherein said elongate member comprises said eyelet.

13. The bait grasping device according to claim 10, wherein said hook has a hook eyelet and an angular offset portion between said hook eyelet and said curved section.

14. A bait grasping device comprising:
a grasping element, said grasping element comprising a first grasping member pivotally engaged to a second grasping member, the first grasping member having at least one first interface member, the second grasping member having at least one second interface member, each of the first interface member and the second interface member comprising a central opening, and a spring in operative engagement between the first grasping member and the second grasping member, said spring being constructed and arranged to permit the pivotal rotation of the first grasping member from the second grasping member prior to engagement of said bait to the grasping element, said spring being further constructed and arranged to pivotally rotate the first grasping member towards the second grasping member during the engagement of the bait to the grasping element; and
a hook assembly, the hook assembly comprising a hook, an elongate member, and an eyelet, said elongate member having a releasable attachment portion, said releasable attachment portion being disposed at an angle relative to said elongate member, said elongate member being positioned through said central openings and said spring,
wherein said hook is disposed proximate to a head of said bait and said hook includes a curved section and a point, wherein the curved section is positioned proximate to the head of the bait and said point extends upwardly and rearwardly from a position proximate to the head of said bait, said first grasping member and said second grasping member being constructed and arranged for positioning on opposite sides of said bait, and said eyelet extending upwardly from said hook assembly during fishing activities.

15. The bait grasping device according to claim 14, wherein said bait is releasably engaged to said bait grasping device.

16. The bait grasping device according to claim 15, said first grasping member comprising a first pinching portion and a first bait engagement clamp, said first bait engagement clamp comprising a plurality of first inwardly directed arcuate prongs.

17. The bait grasping device according to claim 16, said second grasping member comprising a second pinching portion and a second bait engagement clamp, said second bait engagement clamp comprising a plurality of second inwardly directed arcuate prongs.

18. The bait grasping device according to claim 17, wherein said hook comprises said eyelet.

19. The bait grasping device according to claim 17, wherein said elongate member comprises said eyelet.

20. The bait grasping device according to claim 17, wherein said hook has a hook eyelet and an angular offset portion between said hook eyelet and said curved section.
